(19) United States
(12) Patent Application Publication
(10) Pub. No.: US 2012/0086339 A1
(43) Pub. Date: Apr. 12, 2012

(54) GAS DELIVERY DEVICES AND METHODS

(76) Inventors: Geoffrey Morgan Lloyd, College Town (GB); Cormac John Devery, Felbridge (GB); Derrick Ernest Hilton, Frimley (GB); Thomas Bickford Holbeche, Church Crookham (GB); Rodney Stewart Mason, Blackpill (GB); Silvia Beatriz Dougill, London (GB)

(21) Appl. No.: 13/082,535

(22) Filed: Apr. 8, 2011

(30) Foreign Application Priority Data
Apr. 15, 2010 (GB) 1006330.3

(51) Int. Cl. H05H 1/24; H01J 17/26; H01J 7/06

(52) U.S. Cl. 315/111.21; 313/231.31

(57) ABSTRACT

A device 1 for delivering a partially-ionised first stream of gas, comprises a generator 24 of non-thermal plasma having a plasma generating chamber 25 defining a flow path therethrough for the first stream of gas and communicating downstream of the chamber with at least one first outlet 30 from the device for the partially ionised first stream of gas. The device 1 additionally comprises at least one second outlet 34 from the device for a second stream of gas, the configuration of outlets 30 and 34 enabling the second stream to shield the first stream downstream of the said first outlet 30. Interaction of the first stream of gas with the surrounding atmosphere is thus kept down.

### BACKGROUND OF THE INVENTION

This invention relates to a device for delivering a partially-ionised first stream of gas and a method of delivering a partially-ionised first stream of gas.

There is currently much research interest in the use of non-thermal gaseous plasma in a number of therapeutic normal care applications. Suggested uses of a non-thermal gaseous plasma include the treatment of wounds, the cosmetic whitening of teeth, both to remove stains and to whiten tooth enamel, and the cleaning of teeth. See, for example, US-A-2009/004620 and EP-A-2 160 081.

The non-thermal plasma is typically formed by striking an electric discharge between electrodes and a cell containing a helium atmosphere. Typically, the flow of helium passes through the cell and is then directed from the cell to a surface or substrate to be treated. The effect of the electric discharge is to ionise some of the helium atoms in the cell. Other helium atoms are excited by the electric discharge. That is to say, in each excited helium atom, an electron is raised to a quantum level above its ground state. Excited and ionised helium atoms are no longer inert and can directly or indirectly mediate, for example, the sterilisation, at least in part, or the cleaning of a substrate or surface.

We have found that exposure of the gas stream downstream of the plasma cell to the atmosphere can profoundly influence its composition. This is as a result of reaction between components of the atmosphere and components of the gas stream. One important component of the atmosphere is water vapour. Since, for example, the concentration of water vapour in the atmosphere fluctuates, the effect on the composition of the gas stream can be variable and unpredictable.

### SUMMARY OF THE INVENTION

According to the present invention there is provided a device for delivering a partially-ionised first stream of gas, comprising a generator of non-thermal plasma having a plasma generating chamber defining a flow path therethrough and communicating downstream of the chamber of at least one first outlet from the device for the partially-ionised first stream of gas, wherein the device additionally comprises at least one second outlet from the device, for a second stream of gas, the configuration of outlets enabling the second stream to shield the first stream downstream of the said first outlet, and the device is hand-held and hand-operable and comprises a capsule for storing compressed gas, and a housing for housing the capsule and the generator, wherein the capsule is operable to supply the first and second streams of gas.

The invention also provides a method of delivering a partially-ionised first stream of gas, comprising passing a first stream of gas through a plasma-generating chamber, generating a non-thermal gaseous plasma in the first stream of gas as it flows through the chamber, discharging the first stream of gas in partially-ionised state, and shielding the discharged first stream of gas with a second stream of gas, wherein the first and second streams of gas are supplied from a common source.

Preferably, the second outlet is out of communication with the chamber. The second stream of gas therefore bypasses the plasma-generating chamber. By shielding the first stream of gas, the second stream of gas keeps down its interaction with the ambient atmosphere.

The first stream of gas may comprise helium or argon or a mixture of helium and argon. Helium is preferred in view of its thermal properties.

The first stream of gas preferably comprises (a) a noble gas selected from helium, argon and mixtures of helium and argon and (b) an additive gas selected from water vapour, air, oxygen, nitrogen, hydrogen, carbon dioxide, carbon monoxide, nitrous oxide and nitric oxide and any mixtures of any two of more thereof, the additive gas warming up to 1% by volume of the first stream of gas.

The invention is based on a number of different findings in plasma chemistry. The non-thermal plasma may simply be discharged to the atmosphere from the plasma generator, or may travel from the plasma generator in a tube or similar applicator which tube discharges into the atmosphere. If desired, the discharge end of the tube can be inserted the oral cavity and pointed at the surface to be treated. Strictly speaking, once the flow of gas mixture leaves the plasma generator, it is no longer a plasma unless an electrical potential continues to be applied to it. It is simply a gas mixture containing ionic and excited species. The term “plasma” shall be reserved herein for the description of a partially-ionised gas or gas mixture to which an electric potential is applied. The plasma typically glows. The flow of the gas mixture along the applicator shall be referred to as an “afterglow”, and the flow of the gas mixture once it has exited the applicator shall be referred to as a “plume”. Our experimental findings are that if the gas supplied to the plasma generator is essentially pure helium, the resulting plume contains very few ions indeed. It is to be understood that the number of ions in the gas mixture is related to the number of other active species, namely free radicals and excited atoms and molecules. The number of ions may be diminished by recombination with electrons to reform ionised atoms and by reaction with gaseous species entrained from the surrounding atmosphere.

We have further found that there is no simple linear relationship between the population of ionic species in the plume and the concentration of additive gas in the first gas stream. On the contrary, the maximum population is reached when the concentration of additive gas in the first gas stream is much less than 1% by volume. Under our experimental conditions, we were finding, depending on the choice of the additive gas, that the maximum population of ions was achieved at concentration levels of additive gas of less than 0.5% by volume but more than 0.01% by volume.

The total concentration of additive gas in the first gas stream is preferably therefore in the range of 0.01% by volume to 0.5% by volume, more preferably in the range of 0.02% by volume to 0.25% by volume.

We attribute these results partly to a tendency for the additive gas to quench the non-thermal plasma in the plasma generator. Once a maximum has been reached, the plasma-quenching effect reduces the total number of ions present in the plume. Further, in the example of helium as the noble gas, because it has particularly high ionisation energy, ions of the additive gas will, we believe, be formed preferentially in the discharge.

The first stream of gas is preferably provided from a pressure vessel such as a gas cylinder in which it is preformed.

The first stream of gas may be delivered to the oral cavity and may perform one of the following non-clinical or cosmetic oral treatments:

the removal of stains from teeth;

whitening of tooth enamel;

the general cleaning of teeth to destroy harmful bacteria;

the interdental cleaning of teeth;

the freshening of breath;

the treatment of halitosis;

the treatment of gingivitis;

the treatment of periodontal disease.

In each of the above examples, the flow of the first gas stream downstream of the plasma generator may be directed at the tooth or teeth to be treated, or the area of gums to be treated, or in the case of breath freshening or the treatment of halitosis, at the back of the mouth for a sufficient period of time to have a desired effect.

Normal treatment time periods for a typical treatment are from 10 seconds to 10 minutes. Treatment may be repeated daily or at shorter or longer intervals.

Preferred additive gases are those that readily form hydroxyl radicals or active oxygen atoms or molecules. Air, oxygen and water vapour are thus preferred.

The plasma generator preferably has a gas outlet temperature of from 10° C. to 40° C. Higher gas temperatures are generally unsuitable for oral treatments and may damage the mouth or teeth if sustained for too long a period. Temperatures lower than 10° C. may be found uncomfortable by the person undergoing the treatment and in any event are difficult to achieve without unnecessary cooling of the first gas stream. The plasma generator is preferably operated at atmospheric pressure or in the range 0.5 bar to 2.0 bar.

A number of different configurations of first and second outlets may be employed. For example the said second outlet may be annular and may circumscribe the first outlet. In such examples, the first and second outlets are coaxial. In other examples, the second outlet comprises a ring of orifices, the ring circumscribing the first outlet. The ring is typically coaxial with the first outlet.

Typically the said outlets are formed in a nozzle. If desired, the device can take the form of a toothbrush, the said outlets being dispersed in the head of the toothbrush.

A device according to a typical embodiment comprises a control for selectively releasing gas from the capsule so as to form said first and second gas streams.

The housing typically additionally houses a source of electrical energy and energising means electrically connected to the source of electrical energy for creating an electrical discharge within the first stream of gas in the generator.

The gas capsule preferably has a maximum storage pressure of at least 50 bar, typically one in the range 100 bar to 200 bar. The gas capsule has a relatively small capacity, typically in the range 5 to 100 ml water capacity.

The device according to the invention preferably additionally comprises a pressure reducer for reducing pressure of gas released from the capsule. The pressure reducer may comprise an expansion chamber or a pressure control valve. A device according to the invention may also include an on-off valve, for example a solenoid valve, downstream of the pressure reducer, the on-off valve being operable by means of a manual control on the exterior of the housing.

A device according to a typical embodiment also comprises a gas distribution passage downstream of the on-off valve, the gas distribution passage communicating with the said first outlet and the said second outlet.

Typically, the energising means includes a time-delay electrical circuit for delaying the creation of the electrical discharge for a chosen time after initiation of flow of the first gas stream through the generator. Such an arrangement enables impurities to be flushed from the chamber prior to striking the electrical discharge.

If desired the said first outlet provides an outlet from the chamber. Alternatively, the chamber may have an outlet communicating with an applicator and the first outlet is provided at the distal end of the applicator. The distal end of the applicator may thus be of a size and shape that enables it to be inserted into the mouth and pointed, say, at a tooth to be treated.

### BRIEF DESCRIPTION OF THE DRAWINGS

Methods and devices according to the invention will now be described by way of example with reference to the accompanying drawings, in which:

FIG. 1 is a schematic diagram of a device according to the invention;

FIG. 2 is an end view of a first form of applicator for use in the device shown in FIG. 1;

FIG. 3 is an end view of an alternative form of applicator for use in the device shown in FIG. 1; and

FIG. 4 is a schematic sectional side elevation of a third form of applicator for use in the device shown in FIG. 1.

The drawings are not to scale.

### DETAILED DESCRIPTION OF PREFERRED EMBODIMENTS

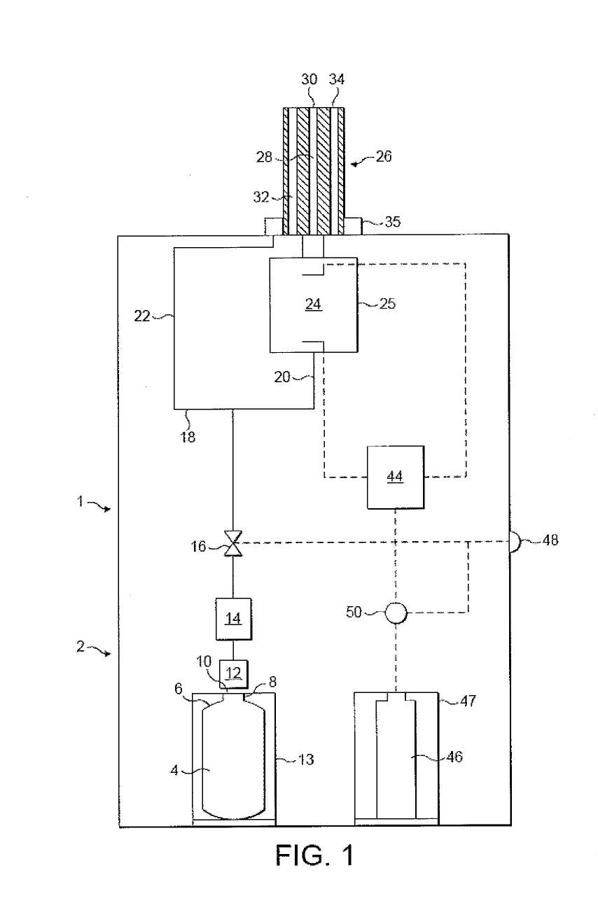

Referring to FIG. 1, a device 1 is shown for generating a non-thermal plasma and to emit a plume comprising partially-ionised gas. The flow of gas plasma is generated and emitted from the device generally at atmospheric pressure. The device comprises a gas capsule 4, or pressure vessel, for holding a gas or gas mixture under pressure and forming a flow of gas through a generator 24 of non-thermal plasma to an applicator 26. Gas released from the gas capsule 4 is energised in the generator 24 to form the non-thermal gaseous plasma.

All the components of the device save for the applicator nozzle 26 and control button(s) are contained within a housing 2. The applicator nozzle 26 engages the housing 2, as will be described below. The housing 2 is typically of a size and shape such that it can be held and operated in the hand. Similarly, the total weight of the device 1 is such that it can be readily held and operated in the hand. The housing 2 may be made of any suitable plastics material. The gas capsule 4 has a water capacity in the range 5 to 100 ml. Typically, its water capacity in the range 20 to 40 ml. The gas capsule 4 is formed with a neck 6 and a mouth 8. A closure 10 is provided in or over the mouth 8. The closure 10 may be a puncturable diaphragm or a valve such as a Schrader valve.

The gas mixture is stored under pressure in the gas capsule 4. The storage pressure is typically at least 50 bar. For example, it may be in the range 100 bar to 200 bar. The gas mixture may be any of those described herein above. For example, it can comprise 99.5% by volume of helium with a balance of one or more additive gases selected from water vapour, oxygen, nitrogen and air.

The housing 2 is provided with an externally accessible compartment 13 in which the gas capsule 4 is received. The compartment 13 may be provided with a holder 12 with which the gas capsule 2 may be engaged. The act of engaging the gas capsule 2 with the holder 12 may actuate a mechanism to puncture or otherwise open the closure 10 so as to permit the flow of gas out of the gas capsule 4. Alternatively, the holder may have a mechanism (not shown) which permits such opening of the gas capsule 2 by operation of an external actuator (not shown) at any time when it is desired to deliver gas from the capsule 4 to the generator 24 of non-thermal plasma.

The housing 2 is internally configured so as to enable gas released from the capsule 4 to flow in a controlled manner to the generator 24 of non-thermal plasma. Immediately downstream of the holder 12 there is provided a pressure reducer 14. The pressure reducer 14 may simply take the form of an expansion chamber or a pressure control valve. The pressure control valve may be of the kind disclosed in US-A-4 655 335. Such a pressure reducer 14 can be designed to give a downstream pressure which remains relatively constant even though the gas pressure in the capsule 4 falls as gas is drawn from it. If desired, the downstream pressure can be set at about 2 bar absolute.

An on-off valve 16, which may, for example, take the form of a solenoid valve is positioned within the housing 2 downstream of the pressure reducer 14. The on-off valve 16 will normally be in a closed position. When it is desired to deliver gas, after having engaged the gas capsule 4 with the holder 12, the on-off valve 16 may be opened by depression of a switch of push-button 48 located externally of the housing in a position such that it can be readily depressed by the user. The on-off valve 16 controls communication of the gas capsule 12 with a gas distribution passage 18. The gas distribution passage 18 feeds gas drawn from the gas capsule 4 to a first conduit 20 and a second conduit 22, the conduits 20 and 22 being in parallel.

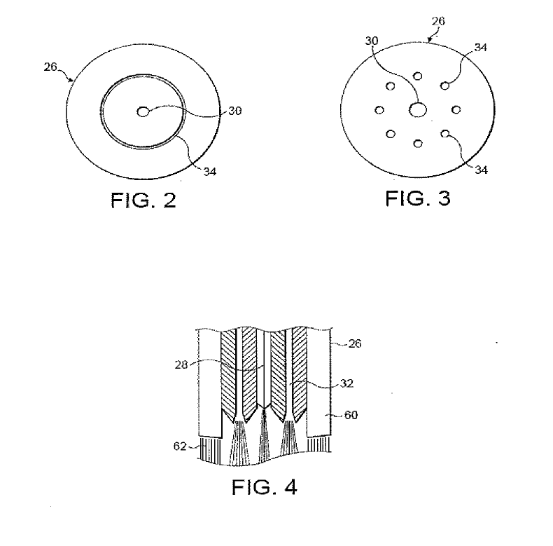

The first conduit 20 communicates with a gas inlet to the plasma generating chamber 25 of the generator 24 of non-thermal plasma. The chamber 25 has an outlet which communicates with an axial passage 28 through the applicator nozzle 26. A first stream of partially ionised gas is thus able to issue from the nozzle 26. The second conduit 22 by-passes the generator 24 and communicates with an outer passage or passages 32 formed through the nozzle 26 from which a second stream of gas issues as a shielding gas to limit reaction between the ambient atmosphere and the first stream of gas. The passage 28 has a circular outlet 30. A single outer passage 32 may surround the passage 28 and be coaxial therewith. The passage 32 may have an annular outlet 34 as illustrated in FIG. 2. Alternatively there may be from, say, 4 to 6 passages 32, each of circular cross-section surrounding the central gas passage 28. Each of the passages 32 has a circular outlet 34. The outlets 34 all lie on a notional ring which is coaxial with the passage 28. Such an arrangement is shown in FIG. 3. In either case, the second conduit 22 communicates with a gas distributor 35. In the embodiment shown in FIG. 2, the gas distributor 35 is located at the side of the applicator nozzle 26 and communicates with the outer gas passage 32 through suitable radial bores (not shown). In the embodiment shown in FIG. 3, the proximal ends of the passages 32 may terminate in the distributor 35.

Referring again to FIG. 1, the chamber 25 of the generator 24 typically has a plurality of electrodes 40 and 42 associated therewith. A signal generator 44 located within the housing 2 is adapted to provide a plasma generating voltage across the electrodes 40 and 42 such that a glow discharge can be created in the gas mixture flowing through the chamber 25. The gas mixture is partially ionised by the voltage signal. Depending on the composition of the gas mixture, the partially ionised gas has the characteristic glow of a particular colour. Electrical energy is provided to the signal generator 44 by the battery or batteries 46 which are received in an externally accessible compartment 47 formed in the housing 2. The battery of batteries 46 may be disposable or rechargeable. When the device 1 is not being used, the battery or batteries 46 are not in electrical circuit with the signal generator 44. When it is desired to use the device 1 in order, say, to clean ones teeth the switch or push button 48 may be actuated to close the switch 50 and thus place the signal generator 44 in electrical circuit with the battery or batteries 46. If desired, instead of using the same control that operates the on-off valve 16, there may be a second push button (not shown) which is dedicated to opening and closing the switch 50. The battery or batteries 46 may typically provide a DC voltage in the order of 12V. The signal generator 44 comprises electrical circuits that are able to transform the voltage into a relatively high frequency pulsed DC or AC signal of the required voltage for the generation of the non-thermal plasma in the generator 24. The peak voltage generated by the signal generator 44 may be in the order of 1 to 6 kV. Each voltage peak may last for one millisecond and voltage peaks may be spaced by an interval of 5 to 10 milliseconds. Electrical circuits including one or more transformers for achieving such a transformation of the voltage are known in the art. Further information is contained in our co-pending application No. PCT/GB2010/000413. Typically, the discharge within the gas mixture flowing through the chamber 25 is through dielectric members (not shown) associated with the electrodes 40 and 42.

In order to operate the device 1 shown in FIGS. 1 to 3, the battery or batteries 46 and the gas capsule 4 may be fitted. The holder 12 is then actuated to open the gas capsule, and the push button or buttons 48 depressed in order to start the flow of gas to the first and second conduits 20 and 22 and to actuate the signal generator 44. Typically, there is an arrangement (not shown) whereby no voltage is struck across the electrodes 40 and 42 until gas has passed for a chosen period of time (say 15 seconds) through the chamber 25. This is to enable impurities to be flushed from the chamber 25 prior to the striking of the discharge therein. Creating an electrical discharge in the gas mixture flowing through the chamber 25 results in the formation of a non-gaseous plasma. This plasma has a temperature of less than 40° C. at the outlet from the chamber 25. Depending on the composition of the gas mixture, the plasma contains a range of different ionic, excited and free radical species. Oxygen radicals and ions and hydroxyl radicals and ions are believed to be particularly effective in, for example, cleaning or whitening teeth. Other ionic and radical species, for example, nitrogen may mediate the formation of active oxygen and hydroxyl species at the surface of a tooth being cleaned or whitened. In order to use the device 1, therefore, the applicator nozzle 26 is pointed, say, at a tooth or teeth to be cleaned and moved thereacross.

The gas supplied to the outer passage or passages 32 of the applicator nozzle 26 shields from premature reaction with atmospheric gases the gas stream issuing from the central outlet 30 of the applicator nozzle 26. As a result, more active species are available for reaction at the surface of the tooth or the surrounding gum.

Typically the shielding gas is approximately equal to the flow of partially ionised gas. If the gas capsule 4 has a water capacity of 21 ml (which is a standard size for such gas capsules) and is charged with gas mixture to a pressure of 200 bar, and the delivery rate of partially ionised gas mixture is in the order of 0.5 to 1 litre per minute the gas capsule 2 typically gives a treatment time in the order of three and a half to 7 minutes and allows additional time for purging of the chamber 25 immediately prior to treatment.

The treatment may be performed after conventional cleaning of teeth with a toothbrush and toothpaste. The treatment with the device 1 may be continued until the gas capsule 4 is approaching exhaustion. A full gas capsule may be substituted for an empty one after each treatment. If desired, the gas capsule 4 may be refillable. Alternatively, it may be disposable.

An alternative embodiment of applicator is shown in FIG. 4. The applicator shown in FIG. 4 may be generally the same as that shown in FIGS. 1 and 2 or FIGS. 1 and 3, but is now in the form of a brush. That is to say the nozzle 26 is provided with an outer sheath 60, the distal end of which is provided with a ring 62 of bristles. The device 1 may therefore be used to brush the teeth at the same time as the partially-ionised gas is directed at them.

Referring again to FIGS. 1 to 3, it is desirable that the applicator nozzle 24 is designed so as to minimise radial gaps between the shielding gas and the central partially-ionised gas stream. Accordingly, the radial distance between the outlet or outlets 34 and the outlet 30 is preferably kept to a minimum. As a result, trapping of atmospheric air between the shielding gas stream and the central partially-ionised gas stream is kept down. The reduction of such impurities is aided by a natural tendency for the gas streams to diverge on issuing from the outlets 30 and 34.

What is claimed is:

1. A device for delivering a partially-ionised first stream of gas, comprising a generator of non-thermal plasma having a plasma generating chamber defining a flow path therethrough for the first stream of gas and communicating downstream of the chamber with at least one first outlet from the device for the partially ionised first stream of gas, wherein the device additionally comprises at least one second outlet from the device for a second stream of gas, the configuration of outlets enabling the second stream to shield the first stream downstream of the said first outlet, and the device is hand-held and hand-operable and comprises a capsule for storing compressed gas, and a housing for housing the capsule and the generator, wherein the capsule is operable to supply the first and second streams of gas.

2. A device according to claim 1, wherein the said second outlet is annular and circumscribes the first outlet.

3. A device according to claim 2, in which the first and second outlets are coaxial.

4. A device according to claim 1, wherein the second outlet comprises a ring of orifices, the ring circumscribing the first outlet.

5. A device according to claim 4, wherein the ring is coaxial with the first outlet.

6. A device according to claim 1 wherein the said outlets are formed in a nozzle.

7. A device according to claim 1, wherein the device is a toothbrush, the said outlets being dispersed in the head of the toothbrush.

8. A device according to claim 1, comprising a control for selectively releasing gas from the capsule for forming said first and second gas streams.

9. A device according to claim 1, wherein the housing additionally houses a source of electrical energy and energising means electrically connected to the source of electrical energy for creating an electrical discharge within the first stream of gas in the generator.

10. A device according to claim 1, additionally comprising a pressure-reducer for reducing the pressure of gas released from the capsule, and an on-off valve downstream of the pressure reducer, the on-off valve being operable by means of a manual control on the exterior of the housing.

11. A device according to claim 10, comprising a gas distribution passage downstream of the on-off valve, the gas distribution passage communicating with the said first outlet and the said second outlet.

12. A device according to claim 9 wherein the energising means includes a time-delay electrical circuit for delaying the creation of the electrical discharge for a chosen time after initiation of flow of the first gas stream through the generator.

13. A device according to claim 1 in which the said first outlet provides an outlet from the chamber.

14. A device according to claim 1, wherein the chamber has an outlet communicating with an applicator and the first outlet is at the distal end of the applicator.

15. A device according to claim 1, wherein the second outlet is out of communication with the chamber.

16. A method of delivering a partially-ionised first stream of gas, comprising passing a first stream of gas through a plasma-generating chamber, generating a non-thermal gaseous plasma in the first stream of gas as it flows through the chamber, discharging the first stream of gas in partially-ionised state, and shielding the discharged first stream of gas with a second stream of gas, wherein the first and second streams of gas are supplied from a common source.

17. A method according to claim 16, wherein the first stream of gas comprises helium or argon or a mixture of helium and argon.

18. A method according to claim 16 wherein the first stream of gas comprises (a) a noble gas selected from helium, argon and mixtures of helium and argon, and (b) an additive gas selected from water vapour, air, oxygen, nitrogen, hydrogen, carbon dioxide, carbon monoxide, nitrous oxide and nitric oxide and any mixtures of any two or more thereof, the additive gas forming up to 1% by volume of the first stream of gas.

19. A method according to claim 18, wherein the additive gas forms from 0.01 to 0.5% by volume of the first stream of gas.

20. A method according to claim 18, wherein the additive gas forms from 0.02 to 0.25% by volume of the first stream of gas.

21. A method according to claim 16, wherein the second stream of gas by-passes the said chamber.
